(19) United States
(12) Patent Application Publication
(10) Pub. No.: US 2015/0301415 A1
(43) Pub. Date: Oct. 22, 2015

(54) LIQUID CRYSTAL DISPLAY DEVICE

(71) Applicant: SHARP KABUSHIKI KAISHA, Osaka-shi, Osaka (JP)

(72) Inventors: Hironobu SAWADA, Osaka-shi (JP); Yuhko HISADA, Osaka-shi (JP); Satoshi MURATA, Osaka-shi (JP); Takehito MORI, Osaka-shi (JP); Ryusuke ASAI, Osaka-shi (JP); Tetsuya FUJIKAWA, Osaka-shi (JP)

(21) Appl. No.: 14/439,260

(22) PCT Filed: Oct. 22, 2013
(86) PCT No.: PCT/JP2013/078532

§ 371 Date: Apr. 29, 2015

(30) Foreign Application Priority Data
Nov. 5, 2012 (JP) 2012-243800

(51) Int. Cl. G02F 1/1343; G02F 1/1362

(52) U.S. Cl. CPC G02F 1/134363; G02F 1/134336; G02F 1/136286; G02F 2001/134372; G02F 2001/136218

(57) ABSTRACT

A liquid crystal display device (1) includes: a first substrate (101); and a second substrate (102), the first substrate and the second substrate being disposed in opposition to one another, wherein, on an opposing surface between the first substrate (101) and the second substrate (102), a pixel electrode (157), a common electrode (155), a shift register (130), a clock signal line (131, 132), and a power supply line (133) are provided, at the first substrate (101), a shield electrode (a first shield electrode part (135) and a second shield electrode part (136)) is provided above the shift register (130) and the power supply line (133), and the shield electrode is not provided above the clock signal line (131, 132).

### TECHNICAL FIELD

The present invention relates to a liquid crystal display device.

The subject application claims priority based on the patent application No. 2012-243800 filed in Japan on Nov. 5, 2012 and incorporates by reference herein the content thereof.

### BACKGROUND ART

Lateral electric field type liquid crystal display devices such as represented by IPS (in-plane switching) and FFS (fringe-field switching) types have been known as one form of liquid crystal display device (Refer to Patent Document 1). In recent years, development has progressed regarding liquid crystal display devices having a GOA (gate-on-array) structure, in which a monolithic structure is made by integrating onto an array substrate a shift register and a gate line group that inputs control signals to the shift register (refer to Patent Document 2). The GOA structure is variously referred to as being gate driverless or having a panel-embedded gate driver (gate-in-panel).

### PRIOR ART DOCUMENT

### Patent Documents

### [Patent Document 1] Japanese Patent Application Publication No. 2005-275054

### [Patent Document 2] Japanese Patent Application Publication No. 2003-222891

### SUMMARY OF THE INVENTION

### Problem to be Solved by the Invention

In a lateral electric field type liquid crystal display device, because electrodes are not formed on the opposing substrate side, potential fluctuation might occur on the opposing substrate side caused by array substrate potential fluctuation, thereby leading to possible light leakage at the peripheral edge part of the display region. In a liquid crystal display device having a GOA structure, a strong electric field is generated from the shift register and the surrounding gate line group (hereinabove referred to as the “GOA circuitry”). Because the GOA circuitry is formed to be narrow and long along one side of the display region, light leakage tends to become noticeable.

Patent Document 1 describes the provision of a conductive layer (shield electrode) above the lead wires in the vicinity of the gate terminals. This constitution is an effective means of suppressing potential fluctuation on the opposing substrate. However, if the same type of structure is applied to a device such as the GOA circuitry, which is required to operate at high speeds, parasitic capacitances occurring between the shield electrode and the GOA circuitry cause signal delay and a voltage drop, so that there is a danger of problems such as a loss of operating margin and an increase in the power consumption of the GOA circuitry.

An object of the present invention is to provide a liquid crystal display device capable of suppressing light leakage in peripheral part of the display region, while suppressing a reduction in the operating margin and an increase in the power consumption of the GOA circuitry.

### Means to Solve the Problem

A first aspect of the present application is a liquid crystal display device including: a first substrate; and a second substrate, the first substrate and the second substrate being disposed in opposition to one another, wherein, on an opposing surface between the first substrate and the second substrate, a pixel electrode, a common electrode, a shift register, a clock signal line, and a power supply line are provided, at the first substrate, a shield electrode is provided above the shift register and the power supply line, and the shield electrode is not provided above the clock signal line.

The shield electrode may include: a first shield electrode part provided above the shift register; and a second shield electrode part provided above the power supply line, wherein the first shield electrode part may be connected to a common trunk line, the common trunk line supplying a common signal to the common electrode, and wherein the second shield electrode part may be connected to a ground electrode.

A region may exist, the region being that the shield electrode is not provided in at least a part above the shift register and the power supply line.

At least a part of the shield electrode may be formed of the same material as the pixel electrode or the common electrode.

The shield electrode may consist of: a first layer formed of the same material as the pixel electrode; and a second layer formed of the same material as the common electrode.

A second aspect of the present invention is a liquid crystal display device including: a first substrate; and a second substrate, the first substrate and the second substrate being disposed in opposition to one another, wherein, on an opposing surface between the first substrate and the second substrate, a pixel electrode, a common electrode, a shift register, a clock signal line, and a power supply line are provided, at the first substrate, a shield electrode is provided above the shift register, the clock signal line, and the power supply line, and a region exists, the region being that the shield electrode is not provided in at least a part above the clock signal line.

The shield electrode may include: a first shield electrode part provided above the shift register; and a second shield electrode part provided above the power supply line; and a third shield electrode part provided above the clock signal line, wherein the shift register and the power supply line may neighbor and sandwich the clock signal line, and wherein the first shield electrode part and the second shield electrode part may be connected by the third shield electrode part.

A region may exist, the region being that the shield electrode is not provided in at least a part above the shift register and the power supply line.

At least a part of the shield electrode may be formed of the same material as the pixel electrode or the common electrode.

The shield electrode may consist of: a first layer formed of the same material as the pixel electrode; and a second layer formed of the same material as the common electrode.

### Effect of the Invention

According to an aspect of the present invention, it is possible to provide a liquid crystal display device capable of suppressing light leakage in peripheral part of the display region, while suppressing a reduction in the operating margin and an increase in the power consumption of the GOA circuitry.

### BRIEF DESCRIPTION OF THE DRAWINGS

FIG. 1 is a simplified drawing of a liquid crystal display device of a first embodiment.

FIG. 2 is a simplified drawing of a shift register included in a gate driver.

FIG. 3 is a timing diagram showing the operation of the shift register.

FIG. 4 is an equivalent circuit diagram of each register stage of the shift register.

FIG. 5 is a timing diagram showing the operation of each stage of the register.

FIG. 6 is a plan view and a cross-sectional view of a liquid crystal display device showing the constitution in the vicinity of the shift register.

FIG. 7 is a plan view showing the constitution in the vicinity of the shift register of a liquid crystal display device of a second embodiment.

FIG. 8 is a plan view showing the constitution in the vicinity of the shift register of a liquid crystal display device of a third embodiment.

FIG. 9 is a plan view showing the constitution in the vicinity of the shift register of a liquid crystal display device of a fourth embodiment.

FIG. 10 is a drawing showing a variation of the cross-sectional structure of the shield electrode.

FIG. 11 is a drawing describing an embodiment.

### EMBODIMENT(S) FOR CARRYING OUT THE INVENTION

### First Embodiment

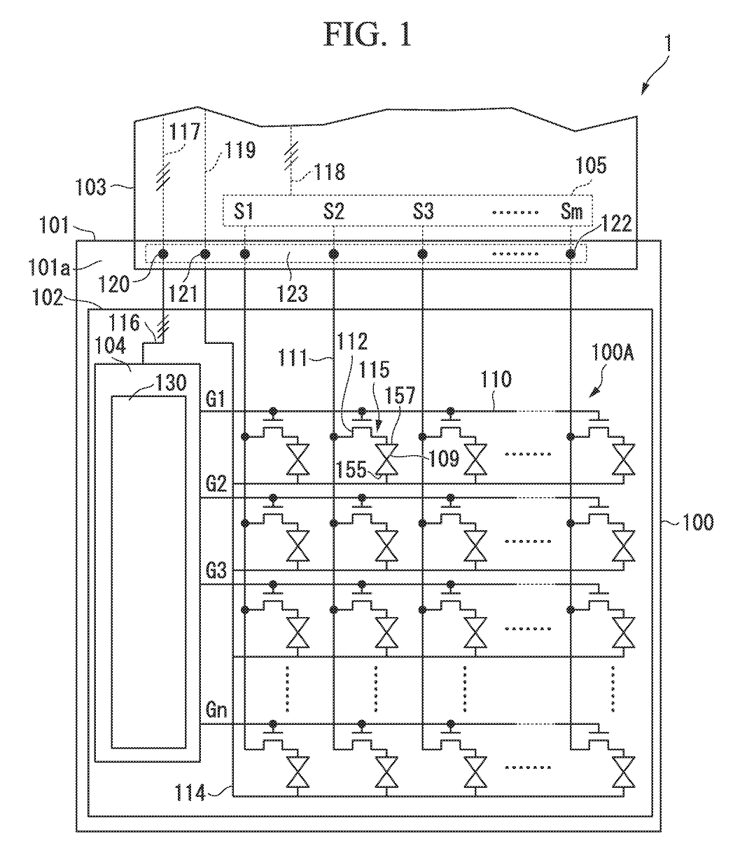

FIG. 1 is a simplified drawing of a liquid crystal display device 1 of the first embodiment.

The liquid crystal display device 1 has a liquid crystal panel 100 and a flexible printed board 103 connected to a terminal part 101a of the liquid crystal panel 100.

The liquid crystal panel 100 has a first substrate 101, a second substrate 102 opposite the first substrate 101, and a liquid crystal layer 109 sandwiched between the first substrate 101 and the second substrate 102. A display region 100A constituted by a plurality (in FIG. 1 m×n) of pixels 115 is provided in the center part of the region in which the first substrate 101 and second substrate 102 are in opposition to one another. In the display region 100A, a plurality (in FIG. 1, n) of gate lines 110 extending in the horizontal direction and a plurality (in FIG. 1, m) of data lines 111 extending in the vertical direction are provided on the first substrate 10 in a matrix arrangement when seen in plan view. A pixel 115 corresponding to one of the colors red, green, and blue is provided at each intersection between a gate line 110 and a data line 111. A plurality of pixels 115 are provided in a matrix arrangement in the horizontal and vertical directions, this plurality of pixels 115 forming the display region 100A.

Each pixel is provided with a pixel electrode 157 and a common electrode 155. The pixel electrode 157 and the common electrode 155 are both provided on the first substrate 101. The liquid crystal display device 1 is a lateral electric field type liquid crystal display device that controls the orientation of a liquid crystal layer by an electric field (lateral electric field) generated between the pixel electrodes 157 and the common electrodes 155. An IPS (in-plane switching) or FFS (fringe-field switching) type can be used as the lateral electrical field scheme. In the case of the present embodiment, for example, the FFS type is used.

A gate driver 104 is provided in a peripheral edge part of the display region 100A of the region of opposition between the first substrate 101 and the second substrate 102. The gate driver 104 includes a shift register 130. A plurality of gate lines 110 are connected to the shift register 130. Gate signals G1, G2, G3, . . . , Gn output from the shift register 130 to the gate lines 110 are supplied to the pixels 115 via thin-film transistors 112. The gate driver 104 includes a plurality of thin-film transistors and interconnects, these thin-film transistors and interconnects being formed simultaneously and in the same process step with the formation of the thin-film transistors 112 and interconnects 111 and 112 formed on the pixels 115. The liquid crystal display device 1 has a GOA (gate-on-array) structure, in which a gate driver 104 is integrally (monolithically) formed over the first substrate 101.

The gate driver 104 has connected thereto a gate line group 116 formed by a plurality of interconnects. Each of the power supply voltage VSS and various control signals such as the clock signals CK1 and CK2 are supplied to the gate driver 104 through the interconnects of the gate line group 116, via the flexible printed board 103. The gate line group 116 is connected to the gate driver control and power supply units (not shown) and the like via the flexible printed board 103. The gate driver 104 inputs these signals and outputs the gate signals G1, G2, G3, . . . , Gn to the gate lines 110 at a prescribed timing. The gate signals G1, G2, G3, . . . , Gn are for selectively switching, in units of rows, the thin-film transistors 112 within a plurality of pixels 115 connected to one gate line 110. Each of the gate signals G1, G2, G3, . . . , Gn are sequentially supplied from the gate driver 104 to the n gate lines 110 for a prescribed amount of time each. Based on an image signal, data signals S1, S2, S3, . . . , Sm responsive to the display are supplied via the data lines 111 to thin-film transistors 112 selected by the gate signals G1, G2, G3, . . . , Gn.

In the first substrate 101, the part that extends outside of the second substrate 102 is a terminal part 101a to which the flexible printed board 103 is connected. The end parts of each line included in the gate line group 116 are connected to a control line external terminal 120 provided in the terminal part 101a. The end parts of each of the plurality of data lines 111 are connected to the data line external terminals 122 provided in the terminal part 101a. The end parts of the common trunk line 114 connected to each of the pixel 115 common electrodes 155 are connected to the common trunk line external terminal 121 provided in the terminal part 101a. In the terminal part 101a, the plurality of external terminals corresponding to each line (the control line external terminals 120, the common trunk line external terminal 121, and the data line external terminal 122) are arranged in the horizontal direction along one side of the first substrate 101.

The flexible printed board 103 provides relaying between the first substrate 101 and a control board (not shown). The flexible printed board 103 is constituted to include a data driver 105 mounted by a technique such as TAB or COF. The data driver 105 inputs an image signal, various clock signals, and various control signals supplied by the data line group 118 from a non-illustrated data driver control unit or the like and outputs the data signals S1, S2, S3, . . . , Sm corresponding to the image signal to the prescribed data lines 111 at a prescribed timing.

A gate line group 117 for the purpose of supplying various control signals, such as clock signals to the gate driver 104 is provided on the flexible printed board 103. In the terminal part 101a, the gate line group 117 is connected to the control line external terminal 120 via a conductive member 123 made of an ACF (anisotropic conductive film). A plurality of lines supplied with the data signals S1, S2, S3, . . . , Sm from the data driver 105 are provided on the flexible printed board 103. These lines are also connected to the data line external terminals 122 via the conductive member 123.

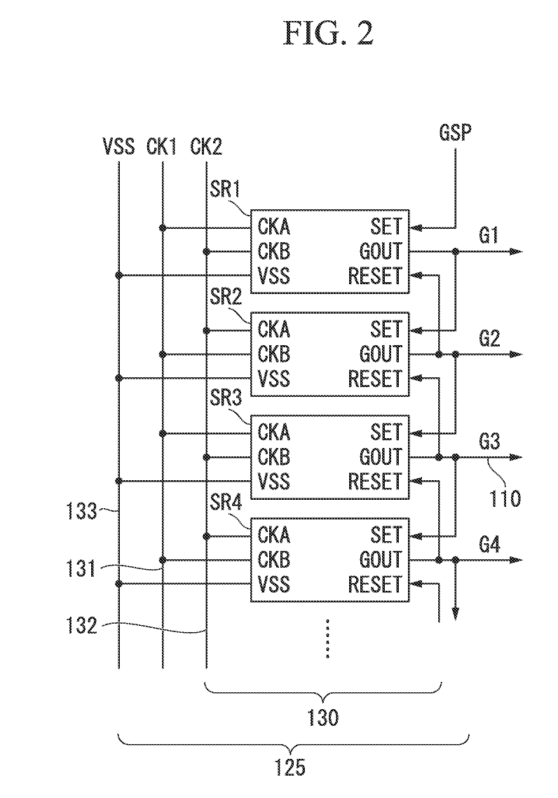

FIG. 2 is a simplified drawing of the shift register 130 included in the gate driver.

The clock signal lines 131 and 132 for supplying the clock signals CK1 and CK2, and the power supply line 133 for supplying the power supply voltage VSS and the like are connected to the shift register 130. The gate line group 116 (refer to FIG. 1) is constituted by the clock signal lines 131 and 132 and the power supply lines and the like. Lines and the like for supplying a gate start pulse GSP to the shift register 130 are included in the gate line group 116. The GOA circuitry 125 is constituted by the shift register 130 and the gate line group.

The shift register 130 has a plurality of registers SR1, SR2, SR3, SR4, and so on that are mutually cascade-connected. Each register SRk (where k is a natural number from 1 to k) has a set terminal SET, an output terminal GOUT, a reset terminal RESET, a low power supply input terminal VSS, and clock input terminals CKA and CKB. The output signal GOUT (represented by the reference number of the output terminal) of the previous stage of register SRk−1 is input to the set terminal SET of each register SRk (k≧2). A gate start pulse GSP is input to the set terminal SET of the first stage register SR1. The output terminal GOUT outputs the output signal Gk to the corresponding gate line. The output signal GOUT of the next stage of register SRk+1 is input to the reset terminal RESET. The Low power supply voltage (hereinafter, VSS may be referred to as the Low power supply voltage), which is the power supply voltage VSS of the low potential side in each stage of the SRk, is input to the Low power supply input terminal VSS. The clock signal CK1 is input to one of the clock input terminal CKA and the clock input terminal CKB, with the clock signal CK2 being input to the other thereof, so that, between neighboring registers, the clock signal input to the clock input terminal CKA alternately switches with the clock signal CK2 input to the clock input terminal CKB.

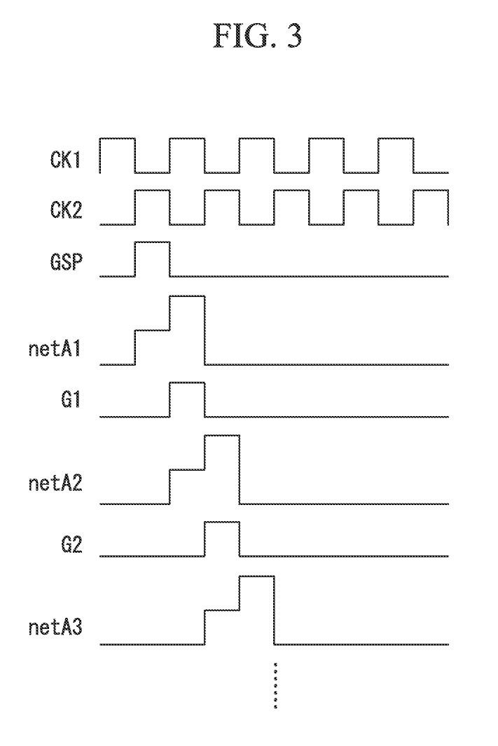

The phase relationship between the clock signal CK1 and the clock signal CK2, as shown in FIG. 3, is complimentary, so that the active clock pulse periods (the high-level periods in this case) do not mutually overlap. The high-level side (active side) voltage of the clock signals CK1 and CK2 is VGH and the low-level side (inactive side) voltage thereof is VGL. The Low power supply voltage VSS is equal to the low-level side voltage VGL of the clock signals CK1 and CK2. Although in this example, the phases of the clock signals CK1 and CK2 are reversed, a relationship is possible in which the active clock pulse period of one of the clock signals is enclosed within the inactive period of the other clock signal.

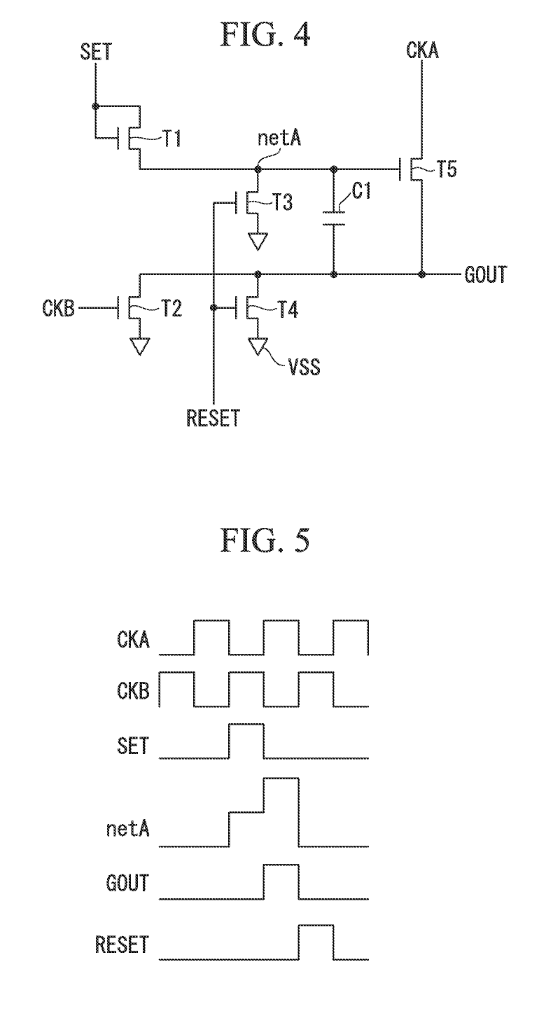

FIG. 4 is an equivalent circuit diagram of each of the registers SRk of the shift register.

A register SRk has the five thin-film transistors T1, T2, T3, T4, and T5 and the capacitance C1. Although the thin-film transistors T1, T2, T3, T4, and T5 are, for example, n-channel type thin-film transistors, p-channel types or complimentary types may be used. A known semiconductor materials such as amorphous silicon, polysilicon, or an oxide semiconductor (for example, IGZO) can be applied as the material of the thin-film transistors.

In the thin-film transistor T1, the gate and drain are connected to the set terminal SET and the source is connected to the gate of the thin-film transistor T5. In the thin-film transistor T5 that is the output transistor of the register SRk, the drain is connected to the clock input terminal CKA and the source is connected to the output terminal GOUT. That is, the thin-film transistor T5, as a transfer gate, either passes or blocks the clock signal input to the clock input terminal CKA. The capacitance C1 is connected between the gate and source of the thin-film transistor T5. The gate of the thin-film transistor T5 and nodes at the same potential are called netA.

In the thin-film transistor T3 the gate is connected to the reset terminal RESET, the drain is connected to the node netA, and the source is connected to the Low power supply input terminal VSS. In the thin-film transistor T4, the gate is connected to the reset terminal RESET, the drain is connected to the output terminal GOUT, and the source is connected to the Low power supply input terminal VSS. In the thin-film transistor T2, the gate is connected to the clock terminal CKB, the drain is connected to the output terminal GOUT, and the source is connected to the Low power supply input terminal VSS.

The operation of the register SRk will be described using FIG. 5.

Until a shift pulse is input to the set terminal SET, the thin-film transistors T4 and T5 are in the high-impedance state and the thin-film transistor T2 goes into the on state each time the clock signal input from the clock input terminal CKB changes to the high level, the output terminal GOUT holding the low state during this period.

If the output signal GOUT gate signal of the previous stage, which is the shift pulse, is input to the set terminal SET, the register SRk goes into the period in which the output pulse is generated, the thin-film transistor T1 switching to the on state and the capacitance C1 charging. By the charging of the capacitance C1, with the high level of the gate signal as VGH and the threshold voltage of the thin-film transistor T1 as Vth, the potential of the node netA rises up to VGH−Vth. As a result, the thin-film transistor T5 goes into the on state, and the clock signal input from the clock input terminal CKA appears at the source of the thin-film transistor T5, but at the instant that the clock pulse (high level) is input to the clock input terminal CKA, the potential at the node netA jumps upward because of the bootstrap effect of the capacitance C1, so that thin-film transistor T5 obtains a large overdrive voltage. This causes the potential level of VGH of the input clock pulse to be propagated to the output terminal GOUT of the register SRk and output, thereby becoming the gate signal Gk (output signal GOUT pulse).

When the input of the gate signal to the set terminal SET ends, the thin-film transistor T1 goes into the off state. Then, because the node netA and the output terminal GOUT of the stage SRk go into the floating state so that the holding of the electric charge is released, the gate signal Gk+1 of the next stage register SRk+1, as the reset pulse input to the reset terminal RESET, places the thin-film transistors T3 and T4 into the on state, thereby connecting the node netA and the output terminal GOUT to the Low power supply voltage VSS. This sets the thin-film transistor T5 to the off state. When the reset pulse input ends, the period in which the register SRk generates an output pulse ends, and the output terminal GOUT goes into the Low holding period again.

In this manner, the gate signal Gk is sequentially output to each of the gate lines, as shown in FIG. 3.

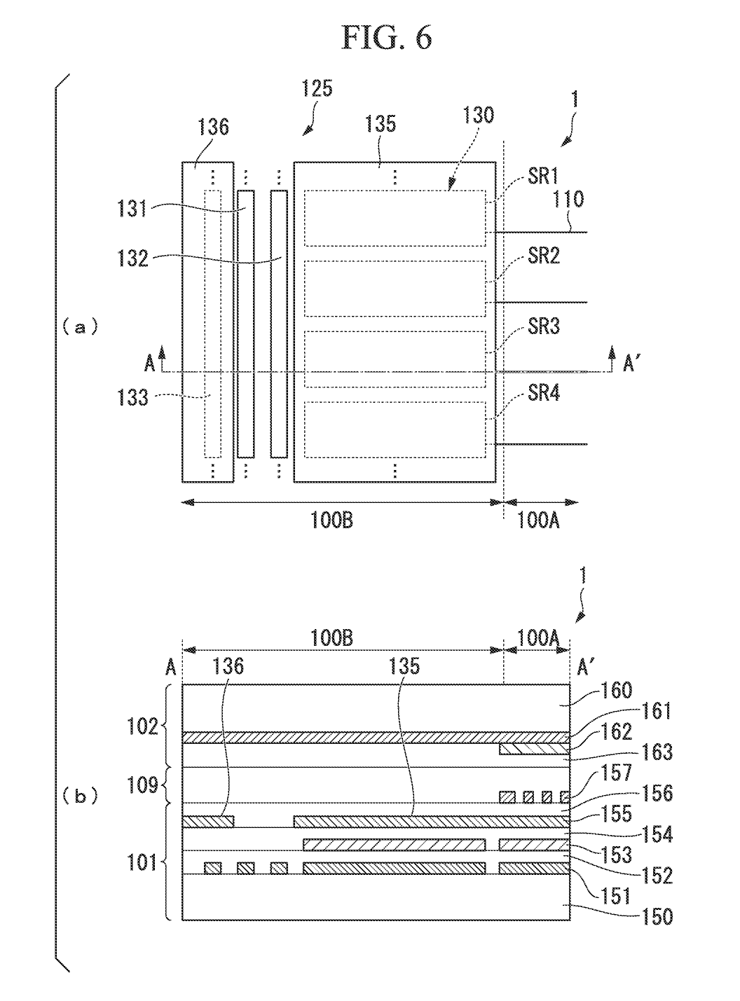

In this case, in a lateral electric field type liquid crystal display device having a GOA structure, the electric field generated from the GOA circuitry causes a potential fluctuation in the second substrate, which is the opposing substrate, so that light leakage might occur at the peripheral edge part of the display region. For this reason, in the present embodiment, as shown in FIG. 6, shield electrodes 135 and 136 that shield the electric field generated from the GOA circuitry 125 are provided above the GOA circuitry 125 on the first substrate (liquid crystal layer side).

The GOA circuitry 125 (gate line group) includes, in addition to clock signal lines 131 and 132 and the power supply line 133, a line for inputting the gate start pulse GSP to the shift register 130. Light leakage, which presents a problem, is light leakage extending as a stripe along one side of the display region 100A. For this reason, in the present embodiment, the parts to be shielded by the shield electrode are the shift register, the clock signal lines 131 and 132, and the power supply line 133 provided along one side of the display region.

FIG. 6(a) is a plan view of the liquid crystal display device 1, showing the constitution in the vicinity of the shift register 130. FIG. 6(b) is a cross-sectional view of the liquid crystal display device 1 along the line A-A in FIG. 6(a).

In FIG. 6(a) and FIG. 6(b), the reference symbol 100B indicates a part of the region of opposition between the first substrate 101 and the second substrate 102 positioned to the outside of the display region 100A (the so-called frame edge region).

The first substrate 101 has a transparent main substrate 150 made of glass, quartz, plastic, or the like as a base. A first interconnect layer 151 is formed on the inner surface side (liquid crystal layer 109 side) of the main substrate 150. A first insulating layer 152 made of a transparent insulating material such as silicon oxide is formed so as to cover the first interconnect layer 151.

The first interconnect layer 151 includes the gates and gate of the thin-film transistors included in the display region 100A and the shift register 130 and the gate lines. The first interconnect layer 151 includes the second clock signal line 132, the first clock signal line 131, and the power supply line 133 of the gate line group. The second clock signal line 132, the first clock signal line 131, and the power supply line 133 are disposed on the other side from the display region 100A, sandwiching the shift register 130 therebetween. Although in the present embodiment the second clock signal line 132, the first clock signal line 131, and the power supply line 133 are disposed in this sequence starting from the side closest to the shift register 130, the sequence of these interconnects is not restricted to this sequence.

A second interconnect layer 153 is formed on the first insulating layer 152. A second insulating layer 154 made of a transparent conductive material such as silicon oxide is formed so as to cover the second interconnect layer 153. A common electrode 155 made of a transparent conductive material such as ITO and the shield electrodes 135 and 136 are formed on the second insulating layer 154. A third insulating layer 156 made from a transparent insulating material such as silicon oxide is formed so as to cover the common electrode 155 and the shield electrodes 135 and 136. A pixel electrode 157 made from a transparent conductive material such as ITO is formed on the third insulating layer 156.

The second interconnect layer 154 includes sources and drains of thin-film transistors and data lines, which are included in the display region 100A and shift register 130. The common electrode 155 and the shield electrodes 135 and 136 are formed of the same material. The common electrode 155 is formed over the entire surface of the display region 100A, and serves as a common electrode for each pixel. The common electrode 155 and the shield electrodes 135 and 136 are made simultaneously by forming a transparent conductive material such as ITO over the entire substrate surface, this being patterned.

The shield electrodes 135 and 136 include the first shield electrode part 135 formed above the shift register 130 and the second shield electrode part 136 formed above the power supply line 133. In the case of the present embodiment, the shield electrodes 135 and 136 are provided only over the shift register 130 and power supply line 133 and are not provided over the clock signal lines 131 and 132. The shift register 130 and the power supply line 133 neighbor and sandwich the clock signal lines 131 and 132, and the first shield electrode part 135 and the second shield electrode part 136 are mutually separated.

If only the effect of electric field shielding is considered, it is desirable to shield all of the GOA circuitry 125 by a shield electrode. However, because parasitic capacitances occur between a shield electrode and the shift register 130 and gate line group, a delay occurs in the signal controlling the shift register 130 or a voltage drop occurs, leading to the risk of a decrease in the operating margin or increase in power consumption of the shift register 130.

For this reason, in the present embodiment, rather than disposing a shield electrode above the clock signal lines 131 and 132, the shield electrodes 135 and 136 are selectively disposed over the power supply line 133 that supplies a low-potential direct-current voltage and the shift register 130. Doing this reduces the influence of signal delay and suppresses the problems of a decrease in operating margin or an increase in power consumption.

The potential on the shield electrodes 135 and 136 is preferably set in the approximate vicinity of the average potential of the display region 100A. The average potential of the display region 100A is approximately in the vicinity of the potential of common electrode 155. For this reason, it is preferable that a signal is applied to the shield electrodes 135 and 136 such that they take on the same potential as the common electrode 155.

In the case of the present embodiment, because the first shield electrode part 135 is formed so as to neighbor the display region 100A, the first shield electrode part 135 is connected to the common electrode 155 that is positioned in the peripheral edge part of the display region 100A and the common trunk line 114 (refer to FIG. 1) that supplies a common signal to the common electrode 155. Because the second shield electrode part 136 is formed so as to be separated from the first shield electrode part 135, it is connected to a non-illustrated ground electrode, separate from the first shield electrode part 135.

Although the potentials of the clock signal lines 131 and 132 are constantly fluctuating, viewed macroscopically, the fluctuation takes a central potential. Because this potential is generally close to the average potential of the display region 100A, the influence on the display by potential fluctuation on the second substrate 102 causing the clock signal lines 131 and 132 is small.

The second substrate 102 has a transparent main substrate 160 made of glass, quartz, plastic, or the like as a base. A black matrix 161, a color filter 162, and an overcoat layer 163 are laminated on the inner surface side (liquid crystal layer 109 side) of the main substrate 160. In contrast to the first substrate 101, on which the pixel electrodes 157 and common electrode 155 are formed, electrodes for fixing the potential are not formed on the second substrate 102. For this reason, there is a tendency to be influenced by the potential fluctuation on the first substrate 101 side. In the present embodiment, however, because the shield electrodes 135 and 136 that shield the electric field of the GOA circuitry 125 are formed on the first substrate 101 side, there is not great a change in the potential of the second substrate 102 in the vicinity of the display region 100A and the influence on the display is small.

As described above, according to the liquid crystal display device 1 of the present embodiment, because the shield electrodes 135 and 136 are formed above the GOA circuitry 125, which has a potential that greatly differs with respect to the average potential of the display region 100A, it is possible to suppress the occurrence of stripe-shaped light leakage in the peripheral edge part of the display region 100A. Because the shield electrodes 135 and 136 are selectively disposed above the shift register 130 and the power supply line 133 that have a relatively large influence on the display and are not disposed above the clock signal lines 131 and 132 that have a relatively small influence on the display, it is possible to effectively suppress the occurrence of light leakage, while reducing as much as possible the problems of signal delay and increased power consumption caused by parasitic capacitances with respect to the shield electrodes 135 and 135.

Although in the present embodiment the shield electrodes 135 and 136 are provided above only the shift register 130 and the power supply line 133 and not provided above the clock signal lines 131 and 132, the shield electrode constitution is not restricted to this. There may exist a region above the clock signal lines 131 and 132 in which a shield electrode is not provided, and it is not absolutely necessary that all of the clock signal lines 131 and 132 be covered by a shield electrode.

Also, in the present embodiment, in order that the potentials on the first shield electrode part 135 and the second shield electrode 136 approach the average potential in the display region 100A, the first shield electrode part 135 is connected to the common trunk line 114 and the second shield electrode part 136 is connected to the ground electrode. However, the lines for inputting signals to the first shield electrode part 135 and the second shield electrode part 136 may be provided separately from the common trunk line 114 and the ground electrode.

Also, although in the present embodiment the power supply line 133 is disposed to the outside of the clock signal lines 131 and 132 (the side opposite from the display region 100A), it may be disposed at a different position, for example between the shift register 130 and the display region 100A. In this case, rather than separating them, it is possible to form as one the first shield electrode part 135 that covers over the shift register 130 and the second shield electrode part 136 that covers over the power supply line 133.

Also, although the present embodiment has shown the example of there being two clock signal lines, 131 and 132, the number of clock signal lines is not restricted to this. The number of clock signal lines may be four, six, eight, or the like.

Also, although in the present embodiment the gate driver 104 is disposed on only one side of the display region 100A, the gate driver 104 may be disposed on two sides, left and right, of the display region 100A.

### Second Embodiment

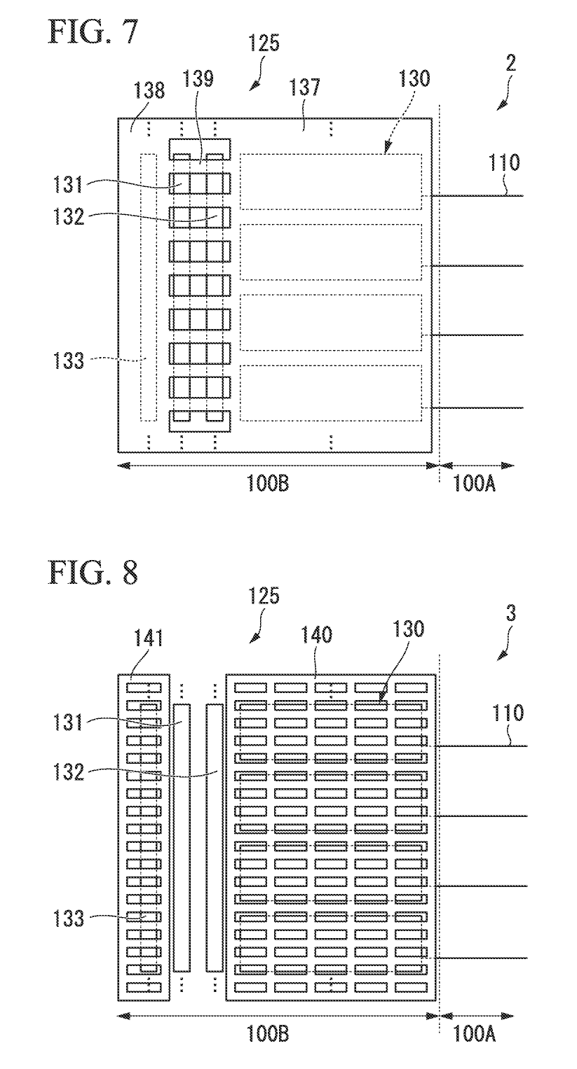

FIG. 7 is a plan view showing the constitution in the vicinity of the shift register 130 in a liquid crystal display device 2 of the second embodiment.

Constituent elements of the present embodiment that are in common with those of the first embodiment are assigned the same reference symbols, and the descriptions thereof are omitted.

The points of difference of the present embodiment with respect to the first embodiment are the existence of a region above the shift register 130, the clock signal lines 131 and 132, and the power supply line 133 on the first substrate 101 in which shield electrodes 135, 136 and 139 are provided, and on at least a part above the clock signal lines 131 and 132 in which a shield electrode is not provided.

The shield electrode of the present embodiment includes the first shield electrode 135 provided above the shift register 130, the second shield electrode 136 provided above the power supply line 133, and a third shield electrode 139 provided above the clock signal lines 131 and 132. The shift register 130 and the power supply line 133 neighbor and sandwich the clock signal lines 131 and 132, and the first shield electrode 135 and second shield electrode 136 are connected by the third shield electrode 139.

The shield electrode parts 135, 136, and 139 are connected to the common electrode 155 (refer to FIG. 1) and to the common trunk line 114 (refer to FIG. 1). The common electrode 155 and the shield electrode parts 135, 136, and 139 are formed simultaneously by forming a transparent conductive material such as ITO over the entire substrate surface, this being patterned.

The third shield electrode part 139, seen from the normal direction of the first substrate, is preferably disposed at a position that does not overlap with lines that connect the clock signal lines 131 and 132 with the shift register 130.

In the present embodiment as well, the same effect as the first embodiment is achieved. Compared with the first embodiment, although because the occurrence of parasitic capacitances between the clock signal lines 131 and 132 and the third shield electrode part 139 there is a greater tendency for problems of signal delay and increased power consumption to occur, because a part over the clock signal lines 131 and 132 is covered by the third shield electrode 139, the electric field shielding effect is greater than in the constitution of the first embodiment. The constitution of the present embodiment is also possible, depending upon the situation of occurrence of light leakage and the demanded performance (operating margin and power consumption).

### Third Embodiment

FIG. 8 is a plan view showing the constitution in the vicinity of the shift register 130 in a liquid crystal display device 3 of the third embodiment.

Constituent elements of the present embodiment that are in common with those of the first embodiment are assigned the same reference symbols, and the descriptions thereof are omitted.

The point of difference of the present embodiment with respect to the first embodiment is the existence of a region over at least a part of the shift register 130 and the power supply line 133 in which a shield electrode is not provided.

The first shield electrode part 140 and the second shield electrode part 141 are constituted, for example, by a conductive layer formed as a mesh (a matrix or a holed configuration). Although in the present embodiment both the first shield electrode part 140 and the second shield electrode part 141 are formed as meshes (matrices or holed configurations), the shield electrode part formed as a mesh may be either one of the first shield electrode part or the second shield electrode part.

When the first shield electrode part 140 is formed as a mesh, it is preferable, when viewed from the normal direction of the first substrate, that apertures be selectively provided in the shield electrode at positions overlapping with lines connecting the clock signal lines 131 and 132 with the shift register 130 and positions overlapping with electrode parts in the floating state, and that apertures not be provided in the shield electrode at positions overlapping with lines connecting the power supply line 133 and the shift register 130.

In the present embodiment as well, the same effect is achieved as in the first embodiment. Although because, compared to the first embodiment, the surface area of the shield electrode parts 140 and 141 is small, the electric field shielding effect is smaller, because the parasitic capacitances between the shield electrode parts 140 and 141 and the GOA circuitry 125 are smaller, problems of signal delay and increased power consumption are suppressed. The constitution of the present embodiment is also possible, depending upon the situation of occurrence of light leakage and the demanded performance (operating margin and power consumption).

### Fourth Embodiment

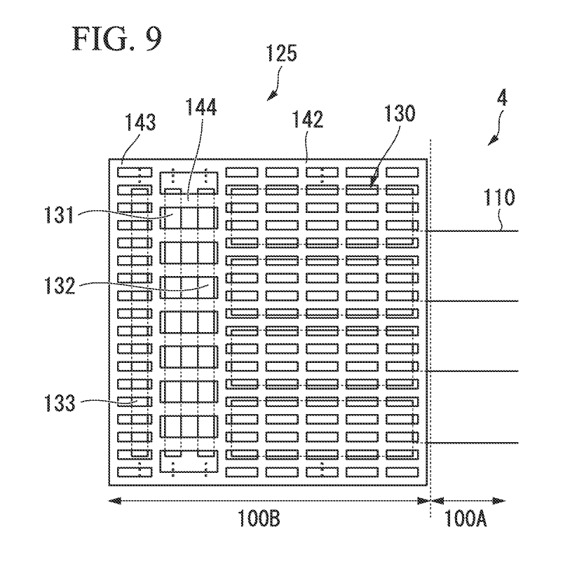

FIG. 9 is a plan view showing the constitution in the vicinity of the shift register 130 of a liquid crystal display device 4 of the fourth embodiment.

Constituent elements of the present embodiment that are in common with those of the second embodiment are assigned the same reference symbols and the detailed descriptions thereof are omitted.

The point of difference of the present embodiment with respect to the second embodiment is the existence of a region over at least a part above the shift register 130 and the power supply line 133 in which a shield electrode is not provided.

The first shield electrode part 142 and the second shield electrode part 143 are constituted, for example, by a conductive layer formed as a mesh (a matrix or a holed configuration). Although in the present embodiment both the first shield electrode part 142 and the second shield electrode part 143 are formed as meshes (matrices or holed configurations), the shield electrode part formed as a mesh may be either one of the first shield electrode part or the second shield electrode part.

When the first shield electrode part 142 is formed as a mesh, it is preferable, when viewed from the normal direction of the first substrate, that apertures be selectively provided in the shield electrode at positions overlapping with lines connecting the clock signal lines 131 and 132 with the shift register 130 and at positions overlapping with electrode parts in the floating state, and that apertures not be provided in the shield electrode at positions overlapping with lines connecting the power supply line 133 and the shift register 130.

The shield electrodes in the present embodiment include the first shield electrode part 142 provided above the shift register 130, the second shield electrode part 143 provided above the power supply line 133, and the third shield electrode part 144 provided above the clock signal lines 131 and 132. The shift register 130 and the power supply line 133 neighbor and sandwich the clock signal lines 131 and 132, and the first shield electrode part 142 and second shield electrode part 143 are connected by the third shield electrode part 144.

The shield electrode parts 142, 143, and 144 are connected to the common electrode (refer to FIG. 1) and the common trunk line 114 (refer to FIG. 1). The common electrode 155 and the shield electrode parts 142, 143, and 144 are formed simultaneously by forming a transparent conductive material such as ITO over the entire substrate surface, this being patterned.

The third shield electrode part 144, seen from the normal direction of the first substrate, is preferably disposed at a position that does not overlap with lines that connect the clock signal lines 131 and 132 with the shift register 130.

In the present embodiment as well, the same effect as the second embodiment is achieved. Although because, compared to the second embodiment, the surface area of the shield electrode parts 142 and 143 is small, the electric field shielding effect is smaller, because the parasitic capacitances between the shield electrode parts 142 and 143 and the GOA circuitry 125 are smaller, problems of signal delay and increased power consumption are suppressed. The constitution of the present embodiment is also possible, depending upon the situation of occurrence of light leakage and the demanded performance (operating margin and power consumption).

### Fifth Embodiment

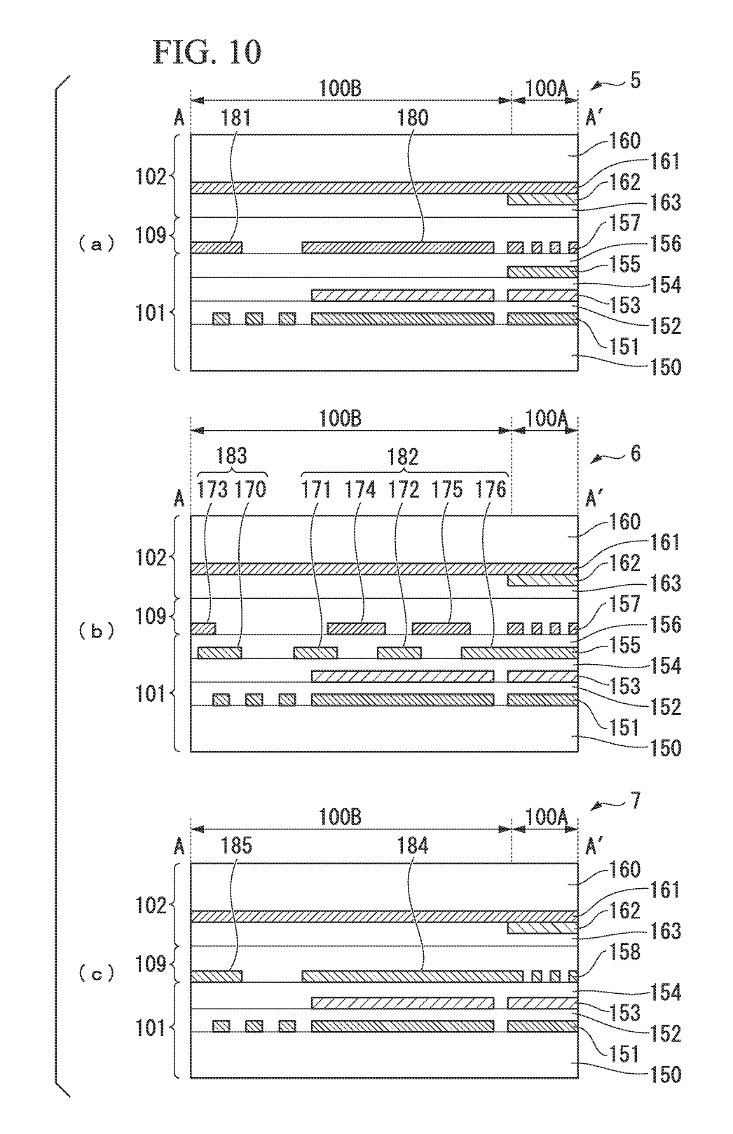

FIG. 10(a) to FIG. 10(c) are drawings showing variations of the cross-sectional structures of the shield electrodes. These variations are applicable to the liquid crystal devices of the first embodiment to fourth embodiment.

Constituent elements of the present embodiment that are in common with those of the first embodiment to the fourth embodiment are assigned the same reference symbols, and the detailed descriptions thereof are omitted.

FIG. 10(a) is an example of the constitution of the liquid crystal display device 5 in which the shield electrodes (the first shield electrode part 180 and the second shield electrode part 181) are formed of the same material as the pixel electrode 157. Although the third shield electrode part is not shown in FIG. 10(a), if the third shield electrode part exists, it is also formed of the same material as the pixel electrode 157. The pixel electrode 157 and these shield electrode parts are formed simultaneously by forming a transparent conductive material such as ITO over the entire substrate surface, this being patterned.

FIG. 10(b) is a constitutional example of a liquid crystal display device 6 constituted by a first layer, the shield electrodes (the first shield electrode part 182 and the second shield electrode part 183) of which are formed of the same material as the pixel electrode 157, and by a second layer, formed of the same material as the common electrode 155.

In FIG. 10(b), the first shield electrode part 182 is constituted by the electrode parts 171, 172 and 176, formed of the same material as the common electrode 155, and by the electrode parts 174 and 175 formed of the same material as the pixel electrode 157. The second shield electrode part 183 is constituted by the electrode part 170, formed of the same material as the common electrode 155, and by the electrode part 173, formed of the same material as the pixel electrode 157. In FIG. 10(b), the electrode parts 173, 174 and 175 are a first shield electrode layer and the electrode parts 170, 171, 172 and 176 are a second shield electrode layer. The common electrode 155 and the electrode parts 170, 171, 172 and 176 are formed simultaneously by forming a transparent conductive material such as ITO over the entire substrate surface, this being patterned. The pixel electrode 157 and the electrode parts 173, 174 and 175 are formed simultaneously by forming a transparent conductive material such as ITO over the entire substrate surface, this being patterned.

Although the third shield electrode part is not shown in FIG. 10(b), if the third shield electrode part exists, it is also constituted by the first layer formed of the same material as the pixel electrode 157 and by the second layer formed of the same material as the common electrode 155. The first layer of the third shield electrode part is formed simultaneously with the first layer of the first shield electrode part 182 and the first layer of the second shield electrode part 183 and the pixel electrode 157. The second layer of the third shield electrode part is formed at the same time as the second layer of the first shield electrode part 182 and the second layer of the second shield electrode part 183 and the common electrode 155.

FIG. 10(c) is an example of the constitution of a liquid crystal display device 7 of the IPS type having comb-tooth shaped pixel and common electrodes. The reference numeral 158 in FIG. 10c indicates comb-shaped electrodes of the pixel and common electrodes. The shield electrodes (the first shield electrode part 184 and the second shield electrode part 185) are formed of the same material as the pixel and common electrodes. Although the third shield electrode part is not shown in FIG. 10(c), if the third shield electrode part exists, it is also formed of the same material as the pixel and common electrodes. The pixel common electrodes and the shield electrode parts thereof are formed simultaneously by forming a transparent conductive material such as ITO over the entire substrate surface, this being patterned.

In the variation from FIGS. 10(a) to 10(c), at least a part of the shield electrode is formed of the same material as the pixel electrode or the common electro. For this reason, it is possible to form the shield electrode and the pixel electrode or the common electrode by a common process.

### Example

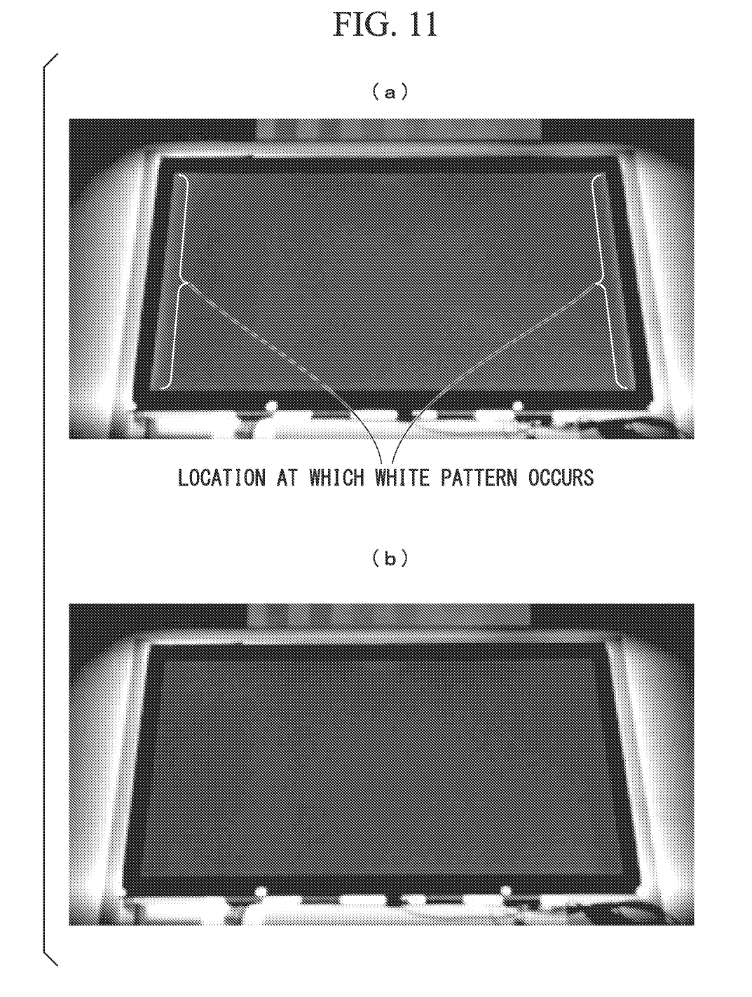

FIG. 11 is a drawing showing a result of investigating the power consumption of the GOA circuitry using a 13.3-inch wide panel. FIG. 11(a) is an example not providing the shield electrode in the GOA circuitry (comparative example) and FIG. 11(b) is an example providing the shield electrode in the GOA circuitry (embodiment).

Although the basic constitutions of the liquid crystal display devices of FIG. 11(a) and FIG. 11(b) are same as in the first embodiment, the GOA circuitry is disposed on two sides, left and right, of the display region, and the number of the clock signal lines is four. The first shield electrode part covering the shift register is connected to the common trunk line, and the second shield electrode part covering the power supply line is connected to the ground electrode.

As shown in FIG. 11(a), in the constitution of the comparative example, the stripe-shaped light leakage is generated on the left and right sides at which the GOA circuitries are formed. In contrast, in the constitution of the embodiment shown in FIG. 11(b), almost no such light leakage occurs. The power consumption of the GOA circuitry of the comparative example was 241 mW, and the power consumption of the GOA circuitry of the embodiment was 225 mW. The power consumption of the embodiment was reduced by 7% relative to the comparative example.

### INDUSTRIAL APPLICABILITY

The present invention can be used in a lateral electric field type liquid crystal display device having a GOA structure.

### DESCRIPTION OF REFERENCE SYMBOLS

1 to 7 Liquid crystal display device
101 First substrate
102 Second substrate
114 Common trunk line
130 Shift register
131, 132 Clock signal line
133 Power supply line
135 First shield electrode part (shield electrode)
136 Second shield electrode part (shield electrode)
139 Third shield electrode part (shield electrode)
140 First shield electrode part (shield electrode)
141 Second shield electrode part (shield electrode)
142 First shield electrode part (shield electrode)
143 Second shield electrode part (shield electrode)
144 Third shield electrode part (shield electrode)
155 Common electrode
157 Pixel electrode
158 Comb-tooth shaped pixel electrode and common electrode
170, 171, 172, 176 Electrode part (Second layer of shield electrode)
173, 174, 175 Electrode part (First layer of shield electrode)
180 First shield electrode part (shield electrode)
181 Second shield electrode part (shield electrode)
182 First shield electrode part (shield electrode)
183 Second shield electrode part (shield electrode)
184 First shield electrode part (shield electrode)
185 Second shield electrode part (shield electrode)

1. A liquid crystal display device comprising:
a first substrate; and
a second substrate, the first substrate and the second substrate being disposed in opposition to one another,
wherein, on an opposing surface between the first substrate and the second substrate, a pixel electrode, a common electrode, a shift register, a clock signal line, and a power supply line are provided,
at the first substrate, a shield electrode is provided above the shift register and the power supply line, and
the shield electrode is not provided above the clock signal line.

2. The liquid crystal display device according to claim 1,
wherein the shield electrode comprises:
a first shield electrode part provided above the shift register; and
a second shield electrode part provided above the power supply line,
wherein the first shield electrode part is connected to a common trunk line, the common trunk line supplying a common signal to the common electrode, and
wherein the second shield electrode part is connected to a ground electrode.

3. The liquid crystal display device according to claim 1,
wherein a region exists, the region being that the shield electrode is not provided in at least a part above the shift register and the power supply line.

4. The liquid crystal display device according to claim 1,
wherein at least a part of the shield electrode is formed of the same material as the pixel electrode or the common electrode.

5. The liquid crystal display device according to claim 4,
wherein the shield electrode consists of:
a first layer formed of the same material as the pixel electrode; and
a second layer formed of the same material as the common electrode.

6. A liquid crystal display device comprising:
a first substrate; and
a second substrate, the first substrate and the second substrate being disposed in opposition to one another,
wherein, on an opposing surface between the first substrate and the second substrate, a pixel electrode, a common electrode, a shift register, a clock signal line, and a power supply line are provided,
at the first substrate, a shield electrode is provided above the shift register, the clock signal line, and the power supply line, and
a region exists, the region being that the shield electrode is not provided in at least a part above the clock signal line.

7. The liquid crystal display device according to claim 6,
wherein the shield electrode comprises:
a first shield electrode part provided above the shift register; and
a second shield electrode part provided above the power supply line; and
a third shield electrode part provided above the clock signal line,
wherein the shift register and the power supply line neighbor and sandwich the clock signal line, and
wherein the first shield electrode part and the second shield electrode part are connected by the third shield electrode part.

8. The liquid crystal display device according to claim 6,
wherein a region exists, the region being that the shield electrode is not provided in at least a part above the shift register and the power supply line.

9. The liquid crystal display device according to claim 6,
wherein at least a part of the shield electrode is formed of the same material as the pixel electrode or the common electrode.

10. The liquid crystal display device according to claim 9,
wherein the shield electrode consists of:
a first layer formed of the same material as the pixel electrode; and
a second layer formed of the same material as the common electrode.
